(19) United States
(12) Patent Application Publication
(10) Pub. No.: US 2013/0331353 A1
(43) Pub. Date: Dec. 12, 2013

(54) CELL-PERMEABLE VARIANTS OF TREHALOSE AND METHODS FOR THE PROTECTION OF LIVING CELLS

(71) Applicant: Margot G. Paulick, Rexford, NY (US)

(72) Inventor: Margot G. Paulick, Rexford, NY (US)

(73) Assignee: UNION COLLEGE, Schenectady, NY (US)

(21) Appl. No.: 13/912,698

(22) Filed: Jun. 7, 2013

Related U.S. Application Data
(60) Provisional application No. 61/656,571, filed on Jun. 7, 2012.

(51) Int. Cl. A01N 1/02

(52) U.S. Cl. CPC A01N 1/0221
USPC 514/53; 435/374; 435/375; 435/252.1; 435/256.8; 536/119

(57) ABSTRACT

A method for synthesizing variants of Tre; novel Tre variants; and a method for introducing Tre in sufficient concentration into the intracellular environment suitable to store treated mammalian cells, treat an aggregation disease, and protect treated cells from oxygen radicals are disclosed.

This application claims the benefit of the filing date of U.S. Provisional Patent Application Ser. No. 61/656,571, filed Jun. 7, 2012, which is hereby incorporated by reference in its entirety.

### BACKGROUND

Living cells are used extensively in both the laboratory and the clinic. For example, red blood cells combat massive blood loss, oocytes enable in vitro fertilization, and human stem cells can cure leukemia. However, many of these cells cannot be stored at ambient temperature, or even refrigerated, for longer than 1-30 days, and preservation via the best available storage techniques, including freezing or dehydrating, significantly decreases cell viability. As a result, a large percentage of stored cells expire before they can be used, leading to a continuous need for donors to replenish the supply.

Certain organisms, including bacteria, fungi, plants, and some insects, are able to naturally withstand environmental stresses such as extreme cold and dehydration. The ability of these organisms to survive under harsh conditions has been linked to high intra- and extracellular concentrations of the disaccharide trehalose (“Tre”) (See Compound 1, FIG. 1). In contrast, mammalian cells do not biosynthesize Tre and are therefore unable to naturally survive extreme cold or desiccating conditions. However, Tre has been shown to improve the survival of mammalian cells after freezing or dehydration when the cells have been exposed to both intra- and extracellular Tre. A significant barrier to the introduction of Tre into mammalian cells is the impermeability of mammalian cell membranes to hydrophilic sugars such as Tre.

In response to this, a number of approaches, including microinjection and genetic engineering, have been developed in attempts to load Tre into living cells. These studies have established that intracellular Tre does improve the survival of cryopreserved and desiccated mammalian cells, but the reported methods for introducing Tre into the intracellular environment are technically demanding or lack applicability to some cell types.

Thus, the art lacks a convenient method for introducing Tre in sufficient concentration into the mammalian intracellular environment to improve the survival of cryopreserved and desiccated mammalian cells.

### BRIEF DESCRIPTION OF THE DRAWINGS

FIG. 1 shows trehalose (Compound 1) a naturally occurring disaccharide and fully acetylated trehalose (Compound 2) synthesized in accordance with the present invention;

FIG. 2 is a bar graph showing the % survival of Jurkat cells after cryopreservation treated in accordance with the present invention as compared with those treated with prior art methods;

FIG. 3 shows partially acetylated derivatives of Tre, Compounds 3, 4, and 5, synthesized in accordance with the present invention;

FIG. 4 shows an esterified cell-permeable derivative of Tre, Compound 6, containing butyryl groups as the hydrophobic esters synthesized in accordance with the present invention and a general formula of the compound;

FIG. 5 is a bar graph showing the intracellular concentration of Tre in NIH-3T3 cells treated in accordance with the present invention as compared with those treated with prior art methods;

FIG. 6 is a bar graph showing the intracellular concentration of Tre in Jurkat cells treated in accordance with the present invention as compared with those treated with prior art methods; and

FIG. 7 shows Compounds 7 through 42 (derivatives of Tre) synthesized in accordance with the present invention.

### DETAILED DESCRIPTION

In an embodiment, the present invention relates to a method for synthesizing variants of Tre, novel Tre variants, and a method for introducing Tre in sufficient concentration into the intracellular environment. In another embodiment, the present invention relates to a method for storing mammalian cells, including treating mammalian cells with a solution containing cell-permeable Tre, subjecting the treated mammalian cells to a preservation technique; and subjecting the preserved cells to a reversing of the preservation technique. In another embodiment, the present invention relates to a method for treating an aggregation disease, including inhibiting the aggregation of disease-related proteins in a patient by treating the patient with a solution containing cell-permeable Tre. In another embodiment, the present invention relates to a method for protecting cells from oxygen radicals, including treating cells with a solution containing cell-permeable Tre.

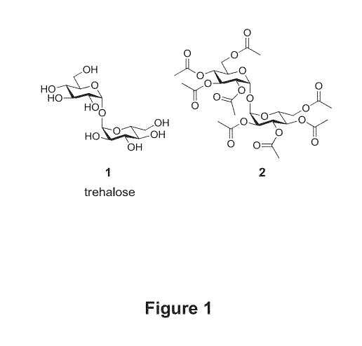

The present invention offers a unique prospect for freezing or dehydrating living cells, e.g., mammalian cells, for long-term preservation and storage. To overcome known obstacles associated with the intracellular introduction of Tre, cell-permeable derivatives of Tre have been chemically synthesized in accordance with the present invention, in which the hydrophilic hydroxyl groups of Tre are masked as hydrophobic esters (Compound 2, FIG. 1). Fully acetylated Tre (Compound 2) has been synthesized and tested for its ability to protect cells during freezing, thus allowing for long-term storage of cells. After diffusion into the cell, these esters are cleaved by nonspecific esterases, generating free Tre.

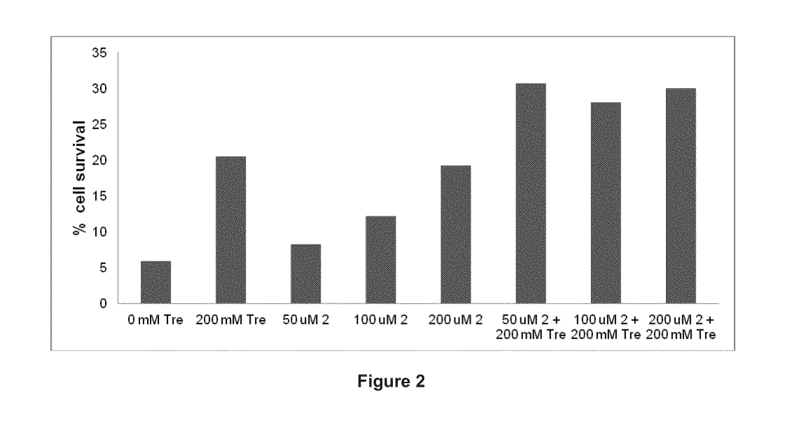

Fully acetylated Tre (Compound 2, FIG. 1) has been synthesized, and incubated with Jurkat cells, a human T-cell line. Jurkat cells incubated with Compound 2 have improved survival after freezing and thawing (FIG. 2). Jurkat cells incubated with a mixture of Compound 2 and free Tre also have improved survival after freezing and thawing (FIG. 2). Our experimental results demonstrate that cell-permeable derivatives of Tre, such as Compound 2 can improve the survival of mammalian cells during cryopreservation.

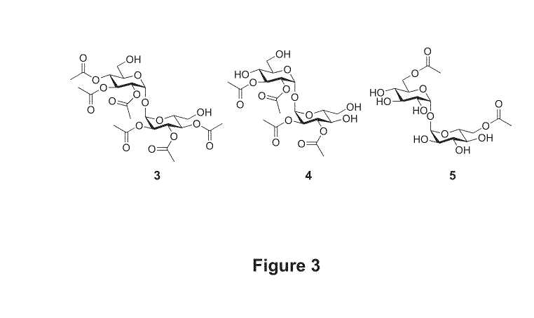

It is preferred that when loading Tre into mammalian cells in accordance with the present method, that the intracellular conversion of fully acetylated Tre to free Tre does not generate damaging levels of acetic acid inside the cells. Partially-acetylated, partially-butyrylated, and other partially-esterified Tre variants are preferred. Suitable partially-acetylated variants of Tre that contain fewer acetyl groups than that of fully acetylated Tre (Compound 2) include Compound 3, Compound 4, and Compound 5, as shown in FIG. 3. A comparison of Tre derivatives Compound 3, Compound 4, and Compound 5 provides an evaluation of the effects of the number of acetyl groups on both cell permeability and viability.

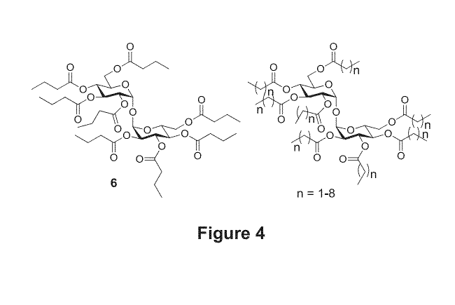

Preferred Tre derivative compounds include acetyl esters of Tre. Suitable compounds also include other types of hydrophobic esters for generating cell-permeable Tre derivatives. Fully butyrylated Tre (Compound 6, FIG. 4) has been synthesized in accordance with the present invention and is likewise a suitable compound for protecting cells from damage during freezing. Other suitable cell-permeable Tre derivatives include those with esters containing from 3-10 carbon atoms. Suitable derivatives of Tre of the present invention are those that contain hydrophobic moieties that protect or mask the hydrophilic hydroxyl groups of Tre in a manner that facilitates the cell-permeability of the compounds and which moieties can be removed after permeating the cell generating free Tre within the cell.

In accordance with a method of the present invention, mammalian cells are incubated with a solution containing cell-permeable variants of Tre. Preferably, the incubation time is at least 24 hours, more preferably, 24 to 96 hours, and most preferably about 48 hours. The cells are then frozen, preferably to about −80° C. or colder and thawed. Suitable freezing techniques include freezing the cells slowly, using for example a cryo 1° C. freezing container (“Mr. Frosty”), and freezing the cells quickly, for example, by plunging them into liquid nitrogen. Preferably, the frozen cells are thawed quickly, but they may also be thawed slowly. The % cell survival is measured, preferably using Trypan blue staining and an automated cell counter. Suitable variations in these freezing and thawing methods are known to those skilled in the art.

Cells can be desiccated using standard desiccation procedures, two of which are described below. In desiccation method 1, after incubation with Tre and/or cell-permeable variants of Tre, mammalian cells are resuspended in lyophilization buffer and freeze-dried on a lyophilizer. After lyophilization, the cell samples are flushed with nitrogen and stored in the dark. Alternatively, in desiccation method 2, mammalian cells are incubated with Tre and/or cell-permeable variants of Tre, and the cell media is removed. The cell samples are then flushed with nitrogen and stored in the dark. Variations of these desiccation methods that can also be used to desiccate the cells are known to those of skill in the art.

In addition to acting as a cellular protectant during freezing and drying conditions, Tre also helps to protect cells from oxygen radicals. The present method is also suitable for use to prepare mammalian and/or other types of cells that might be subjected to oxygen radicals, such as bacteria that are used for bioremediation. Cells are incubated with Tre and/or cell-permeable variants of Tre for a length of time (preferably 24-96 hours). The cells are then incubated with Cr(VI), which will produce oxygen radicals upon its biochemical reduction to Cr(III). Suitable variations for generating oxygen radicals are known to those skilled in the art.

Tre has also been shown to protect cellular proteins from denaturation and aggregation, and it has been demonstrated that Tre can inhibit the aggregation of disease-related proteins, including polyglutamine-expanded huntingtin in Huntington disease and β-amyloid protein in Alzheimer's disease. Therefore, the method of the present invention has potential for use to treat these aggregation diseases. Cells that are genetically engineered to produce mutated huntingtin or β-amyloid are treated with Tre and/or cell-permeable variants of Tre for a length of time (preferably 24-96 hours). The ability of these proteins to aggregate is then evaluated during treatment with Tre and/or cell-permeable variants of Tre. Furthermore, the method of the present invention has the potential for use to treat whole organisms. Organisms, such as mice or humans, are treated with Tre and/or cell-permeable variants of Tre via ingestion or injection for a length of time, after which the ability of these compounds to ameliorate the disease(s) is evaluated.

### EXAMPLE 1

Jurkat cells were incubated for 24 hours with each of the following solutions: 0 mM Tre, 200 mM Tre, 50 μM Compound 2, 100 μM Compound 2, 200 μM Compound 2, 50 μM Compound 2+200 mM Tre, 100 μM Compound 2+200 mM Tre, and 200 μM Compound 2+200 mM Tre. The cells were then slowly frozen at −80° C. using a cryo 1° C. freezing container (“Mr. Frosty”) and thawed quickly. % cell survival was measured using Trypan blue staining and automated cell counter. FIG. 2 shows a comparison of the % survival of Jurkat cells after cryopreservation treated with the solutions noted above.

### EXAMPLE 2

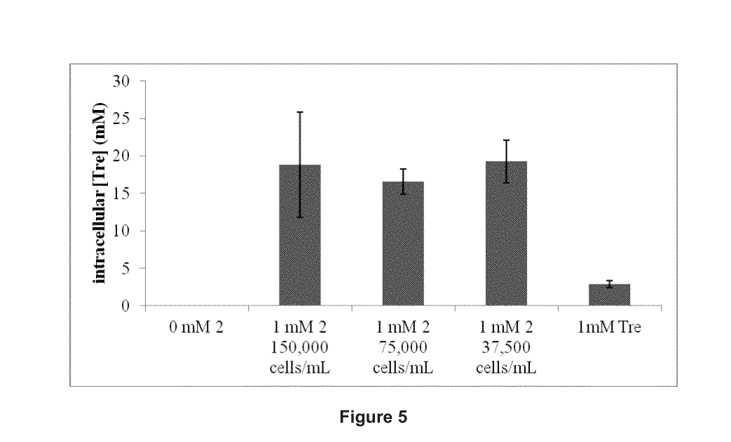

This example demonstrates that the method of the present invention allows for the introduction of free trehalose into mammalian cells at high concentrations. FIG. 5 shows the intracellular concentration of Tre in NIH-3T3 cells, a murine fibroblast cell line, that have been treated with either 0 mM Compound 2, 1 mM Compound 2 for 48 hours at various cell concentrations (37,500 cells/mL, 75,000 cells/mL, and 150,000 cells/mL), or 1 mM Tre (n=4 for all conditions). After treatment with the above solutions, the cells were rinsed with phosphate-buffered saline (PBS, 2×1 mL), lifted with trypsin, centrifuged (3500 rpm×5 min), rinsed again with PBS (1×1 mL), and then counted using a Millipore Scepter cell counter with a 60 μm tip. The cells were centrifuged (3500 rpm×5 min) and snap-frozen in liquid nitrogen and then stored at −80° C. The frozen cell pellets were thawed and resuspended in 50 μL of H₂O. To lyse the cells, the samples were subjected to two snap-freeze/thaw cycles, and then boiled at 95° C. for 10 min. The cell suspensions were then centrifuged at 13,000 rpm for 5 min, and the supernatant was pipetted into a microfuge tube. 5.5 μL of cold 1 M NaOH was added to each microfuge tube to achieve a final concentration of 100 mM NaOH per tube. Standard solutions of Tre were prepared in 100 mM NaOH and were used to generate a calibration curve. The cellular supernatants were then analyzed by high-performance liquid chromatograph (HPLC) using an RCX-10 column and a 100 mM NaOH mobile phase. A refractive index detector was used to detect the Tre peak, and the concentration of Tre in each sample was determined by comparing the integrated peak areas to the calibration curve.

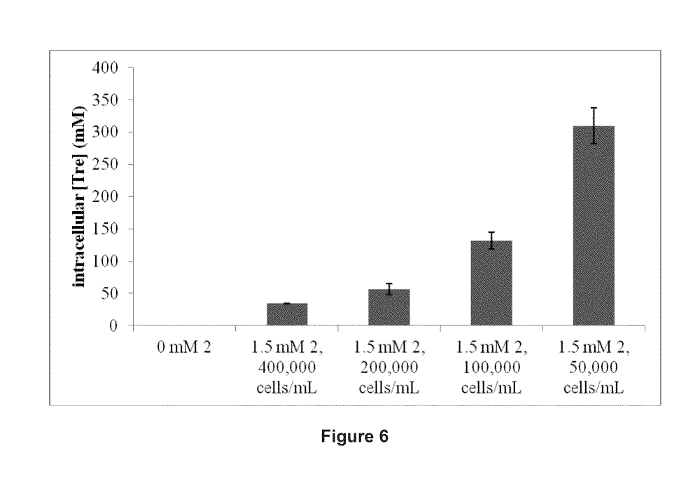

FIG. 6 shows the intracellular concentration of Tre in Jurkat cells, a human T-cell line, that have been treated with either 0 mM Compound 2 or 1.5 mM Compound 2 for 48 hours at various cell concentrations (400,000 cells/mL, 200,000 cells/mL, 100,000 cells/mL, and 50,000 cells/mL). After treatment with the above solutions, the cells were rinsed with PBS (2×5 mL), centrifuged (3500 rpm×5 min), resuspended in 1 mL PBS, and then counted using a Millipore Scepter cell counter with a 40 μm tip. The cells were centrifuged (3500 rpm×5 min) and snap-frozen in liquid nitrogen and then stored at −80° C. The frozen cell pellets were thawed and resuspended in 50 μL of H₂O. To lyse the cells, the samples were subjected to two snap-freeze/thaw cycles, and then boiled at 95° C. for 10 min. The cell suspensions were then centrifuged at 13,000 rpm for 5 min, and the supernatant was pipetted into a microfuge tube. 5.5 μL of cold 1 M NaOH was added to each microfuge tube to achieve a final concentration of 100 mM NaOH per tube. Standard solutions of Tre were prepared in 100 mM NaOH and were used to generate a calibration curve. The cellular supernatants were then analyzed by high-performance liquid chromatograph (HPLC) using an RCX-10 column and a 100 mM NaOH mobile phase. A refractive index detector was used to detect the Tre peak, and the concentration of Tre in each sample was determined by comparing the integrated peak areas to the calibration curve.

As can be seen from the data shown in FIGS. 5 and 6, the method of the present invention allows for the introduction of Tre in sufficient concentrations into the mammalian intracellular environment.

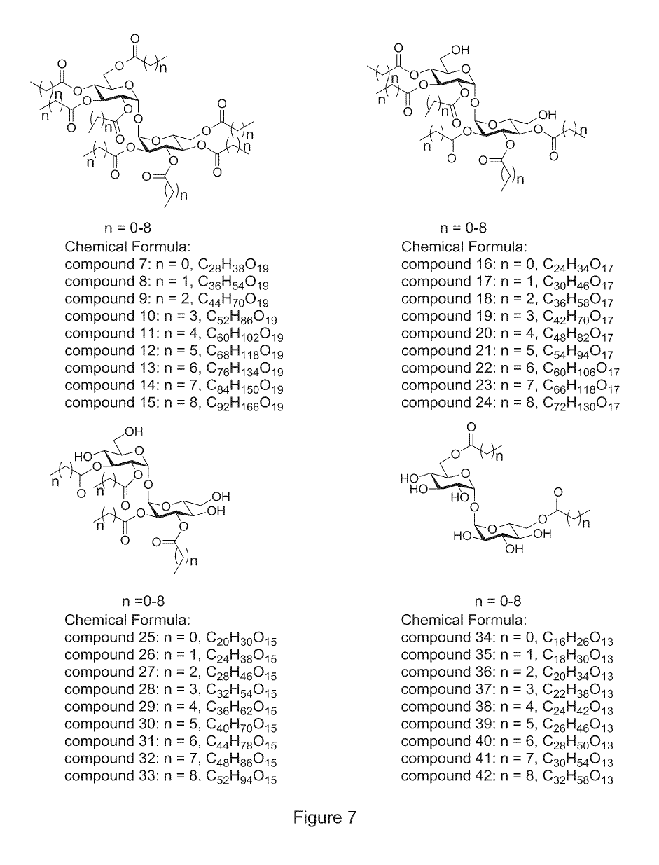

Compounds 7-42 shown in FIG. 7 are suitable for use in the present invention and can be prepared by the procedures in accordance with the following examples.

### EXAMPLE 3

Compounds 7-15 can be prepared as follows: The appropriate anhydride (13.5 eq) is added to a solution of α,α-D-trehalose dihydrate (1 eq) in pyridine (1 mL). A catalytic amount of 4-dimethylaminopyridine (DMAP) (0.1 eq) is added, and the solution is stirred at room temperature for 16 hours. The solvent is removed by rotary evaporation, and the residue is purified by silica gel chromatography.

### EXAMPLE 4

Compounds 16-24 can be prepared as follows: Anhydrous α,α-D-trehalose (1 eq) is coevaporated from toluene and dried overnight in vacuo. Trityl chloride (4 eq) and anhydrous pyridine (4 mL) are added to the trehalose. The solution is heated to 90° C. and stirred for 16 hours. After 16 hours, the appropriate anhydride (10 eq) is added to the reaction solution. The reaction solution is allowed to stir at room temperature for 16 hours. Then the solvent is evaporated in vacuo, and the residue is purified by silica gel chromatography. The resulting purified compound is then dissolved in methylene chloride (3 mL), and iron (III) chloride (2.6 eq) is added to the solution. The reaction is stirred for 1 hour at room temperature, after which water (3 mL) is added to the flask. The solution is stirred for 20 minutes, and then the organic phase is extracted with methylene chloride (2×10 mL) and subsequently washed with saturated NaCl (1×10 mL). The organic phase is dried with anhydrous sodium sulfate, and filtered. The solvent is evaporated in vacuo and then is purified by silica gel chromatography.

### EXAMPLE 5

Compounds 25-33 can be prepared as follows: Anhydrous α,α-D-trehalose (1 eq) and paratoluesulfonic acid (p-TSA) (0.05 eq) are separately coevaporated with toluene and dried overnight in vacuo. Anhydrous DMF (2.5 mL) is added to the dried, anhydrous α,α-D-trehalose. Another portion of anhydrous DMF (2.5 mL) is added to a stirred suspension of p-TSA and (dimethoxymethyl)benzene (1 eq). The solution of p-TSA and (dimethoxymethyl)benzene in DMF is then added to the solution of anhydrous trehalose in DMF, and the entire reaction solution is stirred and heated at 100° C. for 10 minutes. The reaction is concentrated in vacuo for 3 minutes under pressure. The reaction flask is then flushed with N₂, and another portion of (dimethoxymethyl)benzene (1 eq) is added to the reaction. The heating procedure is repeated, and the reaction is again concentrated in vacuo for 3 minutes. The reaction flask is then flushed with N₂, and more (dimethoxymethyl)benzene (0.25 eq) is added to the reaction. After stirring at room temperature for 10 minutes, the reaction is evaporated in vacuo, and the residue is purified by silica gel chromatography. The resulting purified compound is dissolved in a mixture of acetonitrile (3 mL) and pyridine (3 mL). The appropriate anhydride (5.2 eq) is added to the reaction solution, and the reaction is allowed to stir for 16 hours. The solvent is then evaporated in vacuo, and the residue is purified by silica gel chromatography. The resulting purified compound is then dissolved in acetic acid (1.14 mL), and the solution is heated to 95° C. Water (760 μL) is then added to the stirred suspension drop-wise, and the reaction is stirred for 30 minutes at 95° C. Toluene (2×5 mL) is added to the reaction solution, and the solution is concentrated in vacuo, and the residue is purified using silica gel chromatography.

### EXAMPLE 6

Compounds 34-42 can be prepared as follows: Triethylamine (40 eq) is added to a stirred suspension of anhydrous α,α-D-trehalose (1 eq) in anhydrous CH₂Cl₂ (3 mL), and the suspension is cooled to 0° C. Trimethylsilyl chloride (12 eq) is then added drop-wise to the solution, and the reaction is stirred for 12 hours. After 12 hours, the solution is cooled to 0° C., and another portion of trimethylsilyl chloride (4 eq) is added to the solution. The reaction is allowed to stir for 4 hours at room temperature, after which the organic layer is extracted with CH₂Cl₂ (3×20 mL), dried with anhydrous sodium sulfate, filtered, and the solvent is evaporated to afford a cream colored solid. This solid is dissolved in methanol (5.4 mL) and CH₂Cl₂ (1.8 mL), and the solution is cooled to 0° C. Potassium carbonate (0.12 eq) is then added to the solution. The reaction is allowed to stir while warming to room temperature for 1 hour. After 1 hour, glacial acetic acid is added drop-wise to the reaction solution until the pH of the solution drops to 7. The solvent is evaporated in vacuo, and the residue is purified by silica gel chromatography. The resulting purified compound is dissolved in pyridine (3 mL) and the appropriate anhydride (2.6 eq) is added to the solution. A catalytic amount of DMAP (0.05 eq) is added to the reaction, and the reaction is stirred for 16 hours at room temperature. The solvent is evaporated in vacuo, and the residue is purified by silica gel chromatography. The resulting purified compound is dissolved in methanol (6 mL) and CH₂Cl₂ (1 mL). Dry Dowex 50WX8-200 resin (283 mg) is added to this solution, and the reaction is stirred for 15 minutes at room temperature. The reaction solution is filtered, and the solvent is evaporated in vacuo. The resulting residue is purified by silica gel chromatography.

What is claimed is:

1. A method for storing mammalian cells, comprising:
treating mammalian cells with a solution comprising cell-permeable Tre;
subjecting the treated mammalian cells to a preservation technique; and
reversing the preservation technique.

2. The method of claim 1, wherein the solution further comprises free Tre.

3. The method of claim 1, wherein the preservation technique comprises cryopreservation or desiccation.

4. The method of claim 1, wherein the cell-permeable Tre comprises fully acetylated Tre.

5. The method of claim 1, wherein the cell-permeable Tre comprises partially acetylated Tre.

6. The method of claim 1, wherein the cell-permeable Tre comprises fully butyrylated Tre.

7. The method of claim 1, wherein the cell-permeable Tre comprises partially butyrylated Tre.

8. The method of claim 1, wherein the cell-permeable Tre comprises a Tre derivative containing hydrophobic ester substituents having from 3 to 10 carbon atoms.

9. The method of claim 1, wherein the cell-permeable Tre comprises a Tre derivative containing hydrophobic moieties that protect or mask the hydrophilic hydroxyl groups of Tre in a manner that facilitates the cell-permeability of the cell-permeable Tre compounds and which moieties can be removed after permeating the cell, generating free Tre within the cell.

10. The method of claim 1, wherein the cell-permeable Tre comprises at least one of Compounds 2 through 42.

11. A method for treating an aggregation disease, comprising:
inhibiting the aggregation of disease-related proteins in a patient by treating the patient with a solution comprising cell-permeable Tre.

12. The method of claim 11, wherein the solution further comprises free Tre.

13. The method of claim 11, wherein the cell-permeable Tre comprises fully acetylated Tre.

14. The method of claim 11, wherein the cell-permeable Tre comprises partially acetylated Tre.

15. The method of claim 11, wherein the cell-permeable Tre comprises fully butyrylated Tre.

16. The method of claim 11, wherein the cell-permeable Tre comprises partially butyrylated Tre.

17. The method of claim 11, wherein the cell-permeable Tre comprises a trehalose derivative containing hydrophobic ester substituents having from 3 to 10 carbon atoms.

18. The method of claim 11, wherein the cell-permeable Tre comprises at least one of Compounds 2 through 42.

19. The method of claim 11, wherein the cell-permeable Tre comprises a Tre derivative containing hydrophobic moieties that protect or mask the hydrophilic hydroxyl groups of Tre in a manner that facilitates the cell-permeability of the cell-permeable Tre compounds and which moieties can be removed after permeating the cell, generating free Tre within the cell.

20. A method for protecting cells from oxygen radicals, comprising:
treating cells with a solution comprising cell-permeable Tre.

21. The method of claim 20, wherein the cells comprise mammalian, bacterial, or fungal cells.

22. The method of claim 20, wherein the solution further comprises free Tre.

23. The method of claim 20, wherein the cell-permeable trehalose comprises fully acetylated Tre.

24. The method of claim 20, wherein the cell-permeable Tre comprises partially acetylated Tre.

25. The method of claim 20, wherein the cell-permeable Tre comprises fully butyrylated Tre.

26. The method of claim 20, wherein the cell-permeable Tre comprises partially butyrylated Tre.

27. The method of claim 20, wherein the cell-permeable Tre comprises a Tre derivative containing hydrophobic ester substituents having from 3 to 10 carbon atoms.

28. The method of claim 20, wherein the cell-permeable Tre comprises at least one of Compounds 2 through 42.

29. The method of claim 20, wherein the cell-permeable Tre comprises a Tre derivative containing hydrophobic moieties that protect or mask the hydrophilic hydroxyl groups of Tre in a manner that facilitates the cell-permeability of the cell-permeable Tre compounds and which moieties can be removed after permeating the cell, generating free Tre within the cell.

30. A composition of matter selected from the group consisting of the following compounds: 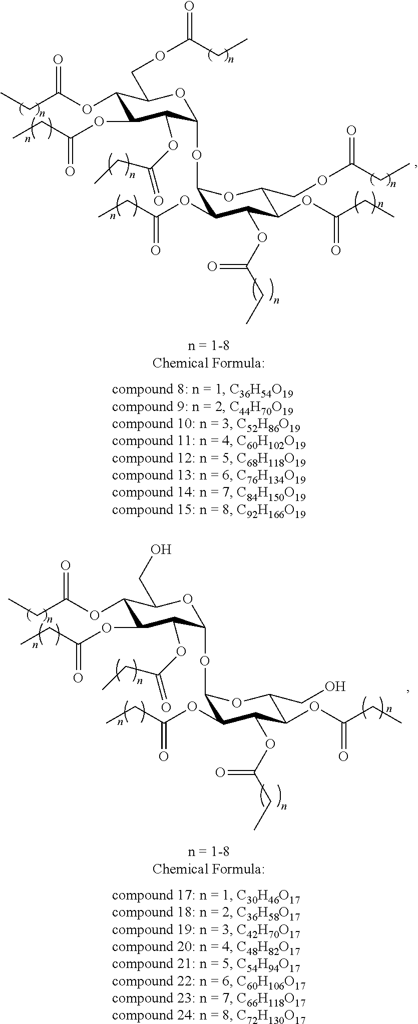 [chemical structure]
